(19) United States
(12) Patent Application Publication
(10) Pub. No.: US 2026/0109570 A1
(43) Pub. Date: Apr. 23, 2026

(54) ELEVATOR SYSTEM COMPRISING AN ELEVATOR CAR POSITION DETERMINING SYSTEM

(71) Applicant: Otis Elevator Company, Farmington, CT (US)

(72) Inventors: Ergün Alkan, Schönefeld (DE); Andreas J. Diethert, Berlin (DE); Ruben Marante, Leganes, Madrid (ES); Mario Marcos, Leganes, Madrid (ES); Miguel De La Cruz, Leganes, Madrid (ES); Alvaro Rodriguez Muñoz, Leganes, Madrid (ES)

(21) Appl. No.: 19/361,076

(22) Filed: Oct. 17, 2025

(30) Foreign Application Priority Data
Oct. 18, 2024 (EP) 24383149.2

(51) Int. Cl. B66B 1/34

(52) U.S. Cl. CPC B66B 1/3492

(57) ABSTRACT

An elevator system (2) includes an elevator car (6) that is configured for traveling in a hoistway (4) along a longitudinal direction (L) between a plurality of landings (8); at least one longitudinal signal transmission component (25) made of a solid or flexible material and extending along the longitudinal direction (L) between the elevator car (6) and a defined position in the hoistway (4); and an elevator car position determining system that is configured for: transmitting a signal (S) through the at least one longitudinal signal transmission component (25); measuring a travel time of the signal (S) that is transmitted through the at least one longitudinal signal transmission component (25); and using the measured travel time for determining the current position of the elevator car (6) in the hoistway (4).

### FOREIGN PRIORITY

This application claims priority to European Patent Application No. 24383149.2, filed Oct. 18, 2024, and all the benefits accruing therefrom under 35 U.S.C. § 119, the contents of which in its entirety are herein incorporated by reference.

### TECHNICAL FIELD

The invention relates to an elevator system comprising at least one elevator car and an elevator car position determining system that is configured for determining the position of the at least one elevator car in the hoistway. The invention is further related to a method of determining the position of at least one elevator car that is configured for traveling in a hoistway between a plurality of landings.

### BACKGROUND

An elevator system typically comprises at least one elevator car that is configured for moving along a hoistway extending between a plurality of landings. In order to allow for a safe and reliable operation of the elevator system, the position of the at least one elevator car in the hoistway needs to be detected reliably and with sufficient accuracy.

It would therefore be beneficial to provide an elevator system including an elevator car position determining system that may be implemented at low costs and that allows for reliably determining the position of the at least one elevator car in the hoistway with high accuracy.

### SUMMARY

An elevator system according to an exemplary embodiment of the invention comprises an elevator car that is configured fortraveling along at least one guide member extending in a hoistway between a plurality of landings. The elevator system comprises at least one longitudinal signal transmission component that is made of a solid or flexible material and that extends along the longitudinal direction between the elevator car and a defined position in the hoistway. The elevator system further comprises an elevator car position determining system that is configured for transmitting a signal through the at least one longitudinal signal transmission component; measuring a travel time of the signal that is transmitted through the at least one longitudinal signal transmission component; and using the measured travel time for determining the current position of the elevator car in the hoistway.

Exemplary embodiments of the invention also include a method of determining a position of an elevator car in a hoistway of an elevator system, wherein the method includes transmitting a signal through at least one longitudinal signal transmission component; measuring the travel time of the signal that is transmitted through the at least one longitudinal signal transmission component; and using the measured travel time for determining the current position of the elevator car in the hoistway. The at least one longitudinal signal transmission component is made of a solid or flexible material and extends between the elevator car and a defined position in the hoistway, in particular a defined position in the vicinity of the top or in the vicinity of the bottom of the hoistway.

An elevator system and a method according to exemplary embodiments of the invention allow for determining the position of an elevator car in the hoistway of an elevator system reliably and with high accuracy.

By transmitting the signal through the at least one longitudinal signal transmission component, the signal is protected from adverse environmental influences. In addition, transmitting the signal through the at least one longitudinal signal transmission component may reduce the influence of environmental conditions, such as changes of the temperature and/or of the humidity of the air in the hoistway, on the travel time of the signal.

In the following, a number of optional features of an elevator system and a method according to exemplary embodiments of the invention are set out. These features may be realized in particular embodiments, alone or in combination with any of the other features, unless explicitly stated otherwise.

The signal may be an ultrasound signal and/or an electromagnetic signal. The signal may be an ultrasound signal in a frequency range of 20 khz to 500 khz. The signal may also be an electromagnetic signal having a frequency in the range of 500 kHz to 100 MHz. The signal may further be an optical signal having a wavelength in the range of 680 nm to 1600 nm.

The signal may in particular be at least one of an electromagnetic signal that is inductively coupled to the at least one longitudinal signal transmission component, an electromagnetic signal that is capacitively coupled to the at least one longitudinal signal transmission component, and an optical signal that is optically coupled to the at least one longitudinal signal transmission component.

The dielectric constant of the solid or flexible material of the at least one longitudinal signal transmission component may differ from the dielectric constant of air. In consequence, the travel time of an electromagnetic signal traveling through the at least one longitudinal signal transmission component may differ from the travel time of an airborne electromagnetic signal that travels over the same distance through air.

Alternatively, or additionally, the speed of sound in the solid or flexible material may differ from the speed of sound in air. In consequence, the travel time of a sound signal traveling through the at least one longitudinal signal transmission component may differ from the travel time of an airborne sound signal that travels over the same distance through air.

The elevator system may further comprise at least one propagation speed measuring device that is configured for measuring a propagation speed of a signal traveling through the at least one longitudinal signal transmission component. The at least one propagation speed measuring device may in particular be configured for measuring the travel time of a signal traveling over a predefined length of the at least one longitudinal signal transmission component for determining the propagation speed of a signal traveling through the at least one longitudinal signal transmission component.

Determining the propagation speed of a signal traveling through the at least one longitudinal signal transmission component allows for compensating for changes of the propagation speed of the signal traveling through the at least one longitudinal signal transmission component that may be caused by varying external influences, such as changes of the temperature and/or changes of the humidity of the air in the hoistway. Compensating for such changes may allow for enhancing the accuracy of the results provided by the elevator car position determining system.

The elevator system may comprise a plurality of propagation speed measuring devices that are arranged at different heights in the hoistway in order to allow for determining the propagation speed of the signal at different heights. In tall buildings, the hoistway may be very long, and the environmental conditions may vary noticeably along the length of the hoistway. Under these circumstances, determining the environmental conditions at different heights in the hoistway may allow for enhancing the accuracy of the results provided by the elevator car position determining system even further.

The at least one longitudinal signal transmission component may include at least one rigid longitudinal signal transmission component. The at least one rigid longitudinal signal transmission component may in particular be a guide member, such as a guide rail, that is configured for guiding the elevator car or a counterweight of the elevator system along the hoistway. Using a guide member, such as a guide rail, as the longitudinal signal transmission component avoids the need of providing an additional longitudinal signal transmission component extending along the hoistway. This may allow for reducing the costs of an elevator system according to an exemplary embodiment of the invention. It may further allow for reducing the workload for installing and maintaining the elevator system.

The elevator car position determining system may comprise at least one emitter and at least one receiver.

The at least one emitter may be located at a defined position in the hoistway, in particular at a defined position in the vicinity of the top or in the vicinity of the bottom of the hoistway. The at least one emitter may be configured for emitting and transmitting the signal into a first longitudinal signal transmission component. The at least one receiver may be located at a defined position in the hoistway, in particular at a defined position in the vicinity of the top or in the vicinity of the bottom of the hoistway, and it may be configured for receiving a signal traveling through a second longitudinal signal transmission component.

In an elevator system comprising such an elevator car position determining system, the elevator car and/or the counterweight of the elevator system may be configured for transferring the signal emitted by the at least one emitter from the first longitudinal signal transmission component into the second longitudinal signal transmission component. As a result, the path length and in consequence the travel time of the signal from the at least one emitter to the at least one receiver depends on the position of the elevator car in the hoistway. In consequence, the position of the elevator car in the hoistway may be determined from a measured travel time, i.e. from the time that it takes the signal to travel from the emitter to the receiver via the first and second longitudinal signal transmission components.

In order to allow for transferring the signal from the first longitudinal signal transmission component to the second longitudinal signal transmission component via the elevator car or via the counterweight, the elevator car or the counterweight may be capacitively or inductively coupled to the first and second longitudinal signal transmission components.

The emitter and the receiver may also be located at any of the elevator car and the counterweight. The first and second longitudinal signal transmission components may be coupled with each other in the vicinity of the bottom or in the vicinity of the top of the hoistway in order to allow the signal that is emitted by the emitter into the first longitudinal signal transmission component to transfer from the first longitudinal signal transmission component to the second longitudinal signal transmission component. In such a configuration, the path length and in consequence the travel time of the signal traveling from the emitter to the receiver depends on the position of the elevator car in the hoistway. Thus, the position of the elevator car in the hoistway may be determined from a measured travel time that it takes the signal to travel from the emitter to the receiver via the first and second longitudinal signal transmission components.

The elevator car and/or the counterweight may be capacitively or inductively coupled to the first and second longitudinal signal transmission components in order to allow for transferring the signal from the emitter provided at the elevator car or counterweight to the first longitudinal signal transmission component and from the second longitudinal signal transmission component to the receiver that is provided at the elevator car or counterweight, respectively.

The at least one longitudinal signal transmission component may include at least one flexible longitudinal signal transmission component, such as a rope, that extends basically along the longitudinal direction of the hoistway.

A flexible longitudinal signal transmission component may be installed easily in the hoistway of an elevator system. A flexible longitudinal signal transmission component may in particular be added conveniently to the hoistway of an existing elevator system, for example for retrofitting an existing elevator system with an elevator car position determining system in accordance with an exemplary embodiment of the invention.

The at least one flexible longitudinal signal transmission member may, for example, include a hoisting rope, a governor rope, or a separate dedicated rope that is provided exclusively for determining the position of the elevator car in the hoistway.

Using a hoisting rope or a governor rope of the elevator system as the at least one flexible longitudinal signal transmission member may allow for reducing the costs of the elevator system. It may further allow for reducing the workload for installing and maintaining the elevator system.

Using a separate dedicated rope that is provided exclusively for determining the position of the elevator car in the hoistway may allow for setting the properties of the rope for optimizing the travel of the signal along the rope, and/or for optimizing the coupling between the rope and the elevator car.

The elevator system may further comprise a reflector that is located at the elevator car and that is configured for reflecting the signal emitted by the emitter towards the receiver. The reflector may include a pulley, in particular a metallic pulley, that is configured for deflecting the rope or a terminal that is configured for terminating the rope.

The elevator system may also comprise an emitter and a receiver that are arranged at the elevator car. The elevator system may further comprise a reflector that is located at a defined position in the vicinity of the top and/or in the vicinity of the bottom of the hoistway and that is configured for reflecting a signal emitted by the emitter towards the receiver. The reflector may include a pulley, in particular a metallic pulley, that is configured for deflecting the rope or a terminal that is configured for terminating the rope.

A method according to an exemplary embodiment of the invention may include reflecting the signal with a reflector that is located at the elevator car or at a defined position in the hoistway.

Employing a reflector may allow for enhancing the signal strength of the reflected signal. In consequence, the reflected signal may be detected more easily and more reliably by the receiver.

The travel time of the signal transmitted through the at least one longitudinal signal transmission component may be a first travel time, and the at least one longitudinal signal transmission component may be configured such that the first travel time does not depend on the position of the elevator car in the hoistway.

The elevator car position determining system may further comprise a second emitter and/or a second receiver. The second emitter may be configured for emitting a second signal that is transmitted to the second receiver via a path having a variable length that changes according to the position of the elevator car in the hoistway so that a second travel time that it takes the second signal to travel from the second emitter to the second receiver varies when the position of the elevator car in the hoistway changes.

Determining the position of an elevator car in a hoistway of an elevator system may include transmitting a second signal between a second emitter and second receiver so that a second travel time of the second signal between the second emitter and second receiver varies according to the position of the elevator car in the hoistway; determining the second travel time and a difference between the first and second travel times; and determining the current position of the elevator car in the hoistway from the difference between the first and second travel times.

The first and second travel times may vary due to changes of environmental conditions, such as the temperature and/or the humidity of the air in the hoistway. Such variations may, however, cancel each other when the difference between the first and second travel times is calculated. As a result, the position of the elevator car in the hoistway may be determined with a very high accuracy even when the environmental conditions in the hoistway change.

The second emitter may be an airborne signal emitter that is configured for emitting an airborne signal that is transmitted via the air or space in the hoistway above and/or below the elevator car. The second receiver may be an airborne signal receiver that is configured for receiving the airborne signal emitted by the airborne signal emitter. Employing an airborne signal emitter and an airborne signal receiver avoids the need of providing a second longitudinal signal transmission component in the hoistway for transmitting the second signal. This may allow for reducing the costs of the elevator system. It may further allow for reducing the workload for installing and maintaining the elevator system.

In a further configuration, the second emitter may be configured for emitting the second signal into a guide member, such as a guide rail, that is configured for guiding the elevator car or the counterweight along the hoistway; and the second receiver may be configured for receiving the second signal from the or another guide member, such as a guide rail.

In another configuration, the second emitter may be configured for emitting the second signal into a rope, such as a hoisting rope or a governor rope, that is coupled to the elevator car or to the counterweight; and the second receiver may be configured for receiving the second signal from the rope that is coupled to the elevator car or to the counterweight.

Employing a guide member or a rope for transmitting the second signal allows for a very reliable transmission of the second signal that is well protected against adverse external influences, such as moisture, dust or dirt, which may be present in the hoistway.

The elevator car position determining system may be configured for measuring a first travel time of a first signal traveling along a lower path extending between the elevator car and a position in the vicinity of the bottom of the hoistway; measuring a second travel time of a second signal traveling along an upper path extending between the elevator car and a position in the vicinity of the top of the hoistway; and determining the current position of the elevator car in the hoistway from the difference between the first and second travel times.

This allows for determining the current position of the elevator car in the hoistway from the difference between the first and second travel times without the need for knowing or determining the propagation speed of the signal.

The elevator car position determining system may be configured for determining the distance between the elevator car and a defined position in the vicinity of the top of the hoistway. Alternatively, the elevator car position determining system may be configured for determining the distance between the elevator car and a defined position in the vicinity of the bottom of the hoistway.

The elevator car position determining system may further be configured for determining both, the distance between the elevator car and the defined position in the vicinity of the top of the hoistway as well as the distance between the elevator car and the defined position in the vicinity of the bottom of the hoistway.

Since the sum of the distances between the elevator car and the defined position in the vicinity of the top of the hoistway and the distance between the elevator car and the defined position in the vicinity of the bottom of the hoistway must remain constant independently of the current position of the elevator car, determining the distance between the elevator car and the defined position in the vicinity of the top of the hoistway as well as the distance between the elevator car and the defined position in the vicinity of the bottom of the hoistway allows for checking the consistency and accuracy of the elevator car position determining system.

The additional features, modifications and effects that have been described with respect to elevator systems comprising a passenger detection system according to exemplary embodiments of the invention apply to the above mentioned method of determining the position of the at least one elevator car in an elevator system in an analogous manner.

### BRIEF DESCRIPTION OF THE DRAWINGS

In the following, exemplary embodiments of the invention are described in more detail with respect to the enclosed figures:

FIG. 1 depicts a schematic view of an elevator system according to an exemplary embodiment of the invention.

FIG. 2A depicts a schematic view of an elevator system comprising an elevator car position determining system according to an exemplary embodiment of the invention.

FIG. 2B depicts a sectional view through a coil of an elevator system as it is depicted in FIG. 2A with a rope extending through the coil.

FIG. 3 depicts a schematic view of an elevator system comprising an elevator car position determining system according to a further exemplary embodiment of the invention.

FIG. 4 depicts a schematic view of an elevator system comprising an elevator car position determining system according to another exemplary embodiment of the invention.

FIG. 5 depicts a schematic view of an elevator system comprising an elevator car position determining system according to yet another exemplary embodiment of the invention.

FIG. 6 depicts a schematic view of an elevator system comprising an elevator car position determining system according to a further exemplary embodiment of the invention.

FIG. 7 depicts a schematic view of an alternative embodiment of an elevator system comprising an elevator car position determining system according to an exemplary embodiment of the invention.

### DETAILED DESCRIPTION OF THE INVENTION

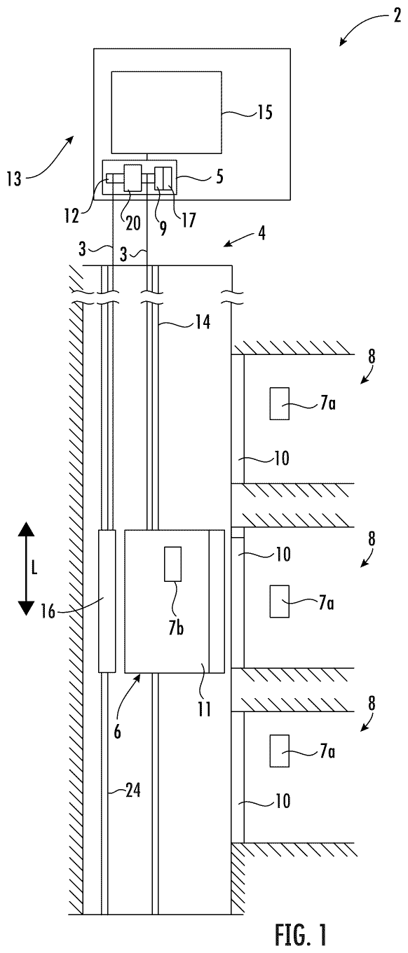

FIG. 1 schematically depicts an elevator system 2 according to an exemplary embodiment of the invention.

The elevator system 2 comprises a hoistway 4 extending in a longitudinal direction L between a plurality of landings 8 located on different floors. The elevator system 2 includes an elevator car 6 that is arranged in the hoistway 4 for being moved along the longitudinal direction L between the plurality of landings 8. The elevator car 6 may in particular be movable along at least one elevator car guide member 14, such as at least one elevator car guide rail, provided in the hoistway 4 and extending along the longitudinal direction L.

The longitudinal direction L may be oriented in a vertical direction, as it is depicted in FIG. 1. In an alternative embodiment that is not depicted in the figures, the longitudinal direction L may be inclined with respect to the vertical direction.

Although only a single elevator car guide member 14 is depicted in FIG. 1, the elevator system 2 may comprise a plurality of elevator car guide members 14 extending parallel to each other.

Although only a single elevator car 6 is depicted in FIG. 1, exemplary embodiments of the invention may also include elevator systems 2 comprising a plurality of elevator cars 6 moving in one or more hoistways 4.

The elevator car 6 is movably suspended by means of a tension member 3. Although only a single tension member 3 is depicted in FIG. 1, exemplary embodiments of the invention may also include elevator systems 2 comprising a plurality of tension members 3.

The at least one tension member 3, for example a rope or belt, is coupled to an elevator drive system 5. The elevator drive system 5 comprises a motor 9 for rotatably driving a shaft 12, and a drive 17 that harnesses and controls the electrical energy supplied to the motor 9. The elevator drive system 5 is configured for driving the at least one tension member 3, which is coupled to the shaft 12 via traction, in order to move the elevator car 6 in the hoistway 4 along the longitudinal direction L between the plurality of landings 8.

The elevator drive system 5 is further provided with at least one elevator brake 20 for braking rotation of the shaft 12 in order to allow for stopping movement of the elevator car 6 and holding the elevator car 6 at a desired position in the hoistway 4.

Optionally, the elevator system 2 may comprise a counterweight 16. The counterweight 16 may be attached to the at least one tension member 3 opposite to the elevator car 6 and configured for moving concurrently and in opposite direction with respect to the elevator car 6. The counterweight may move along at least one counterweight guide member 24, such as at least one counterweight guide rail, provided in the hoistway 4 and extending along the longitudinal direction L.

The at least one tension member 3 may be a rope, e.g. a steel cord, or a belt, in particular a coated steel belt. The at least one tension member 3 may be uncoated. Alternatively, the at least one tension member 3 may be coated with a coating, e.g. with a coating having the form of a polymer jacket. In a particular embodiment, the at least one tension member 3 may be a belt comprising a plurality of polymer coated steel cords (not shown). The elevator system 2 may have a traction drive including a traction sheave for driving the at least one tension member 3.

In the exemplary embodiment shown in FIG. 1, a 1:1 roping is employed for suspending the elevator car 6. The type of the roping is, however, not essential for the invention and different kinds of roping, e.g. a 2:1 roping or a 4:1 roping may be employed as well.

A landing door 10 is provided at each of the landings 8. The elevator car 6 is provided with a corresponding elevator car door 11 for allowing passengers to transfer between a landing 8 and the interior of the elevator car 6, when the elevator car 6 is positioned at the respective landing 8.

For moving the elevator car 6 along the hoistway 4 between the different landings 8, the elevator drive system 5 may be controlled by an elevator controller 15 of the elevator system 2.

The elevator system 2 may be a machine room-less elevator system 2. In an alternative embodiment, the elevator system 2 may comprise a machine room 13 housing the elevator drive system 5 and the elevator controller 15.

Input to the elevator controller 15 may be provided via landing control panels 7a provided on every landing 8, in particular in the vicinity of the landing doors 10, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a. The landing control panels 7a and the elevator car control panel 7b may be coupled with the elevator controller 15 by means of electrical wiring not shown in FIG. 1, in particular by an electric bus, or by wireless data connections.

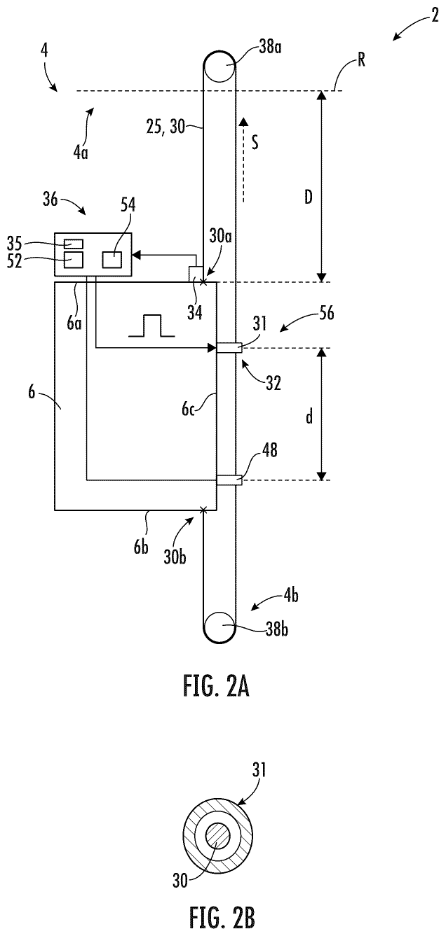

FIG. 2A depicts a schematic view of an elevator system 2 comprising an elevator car position determining system according to an exemplary embodiment of the invention.

In order to enhance the clarity of the illustration, only the components of the elevator system 2 that are relevant for determining the position of the elevator car 6 in the hoistway 4 are depicted in FIGS. 2 to 7.

The exemplary embodiment of an elevator system depicted in FIG. 2A comprises a longitudinal signal transmission component 25 in the form of a rope 30 that extends from a top of the elevator car 6, in particular from a roof 6a of the elevator car 6 over a first pulley 38a provided in the vicinity of the top of the hoistway 4 and a second pulley 38b provided in the vicinity of the bottom 4b of the hoistway 4 to the bottom of the elevator car 6, in particular to a floor 6b of the elevator car 6.

When passing the elevator car 6 between the first and second pulleys 38a, 38b, the rope 30 extends through a coil 31 that is provided at a sidewall 6c of the elevator car 6 facing the rope 30. A receiver 34 is provided at the top of the elevator car 6 adjacent to an upper end 30a of the rope 30 mounted to the elevator car 6.

FIG. 2B depicts a sectional view through the coil 31 with the rope 30 extending through the coil 31.

Referring to FIG. 2A again, the elevator system 2 further comprises a controller 36 that is electrically coupled to the coil 31 and to the receiver 34.

The controller 36 may emit an electromagnetic signal S via the coil 31 into the rope 30. In such a configuration, the coil 31 acts as an emitter 32 that is inductively coupled to the rope 30.

In an alternative configuration that is not explicitly depicted in the figures, the emitter 32 may be coupled to the rope 30 capacatively or optically.

The rope 30 may be made of steel and the electromagnetic signal S may be an electromagnetic signal S having a frequency in the range of 500 kHz to 100 MHz.

Alternatively, the rope 30 may be configured for transmitting an optical signal S, and the emitter 32 may be configured for emitting an optical signal S into the rope 30. The optical signal S may have a wavelength in the range of 680 nm to 1600 nm. The rope 30 may, for example, be or comprise at least one optical fiber for transmitting the optical signal S.

In alternative embodiments, the signal S may be an ultrasound signal S, in particular an ultrasound signal S in a frequency range of 20 khz to 500 khz, and the emitter 32 may be configured for emitting an ultrasound signal S into the rope 30.

The signal S that is emitted by the emitter 32 into the rope 30 travels along the rope 30. The signal S travels in particular along the rope 30 until it reaches the upper end 30a of the rope 30 that is attached to the top of the elevator car 6. When the signal S reaches the upper end 30a of the rope 30, it is detected by the receiver 34 that is provided at the upper end 30a of the rope 30 on top of the elevator car 6.

When the propagation speed of the signal S along the rope 30 is known, the controller 36 is able to calculate the length of the section of the rope 30 between the emitter 32 and the receiver 34 from a measured travel time (“time of flight”) of the signal S, i.e. from the measured time difference between emitting the signal S into the rope 30 by the emitter 32 and receiving the signal S with the receiver 34 after the signal S has traveled along the rope 30 from the emitter 32 to the receiver 34.

The controller 36 may comprise a Time-To-Digital-Converter (TDC) 35 for measuring the travel time of the signal S between the emitter 32 and the receiver 34.

From the calculated length of the section of the rope 30 extending between the emitter 32 and the receiver 34, the controller 36 is further able to calculate the distance D between the elevator car 6 and the top 4a of the hoistway 4, in particular the distance D between the elevator car 6 and a virtual reference line R that has been defined in the hoistway 4. The calculated distance D defines the position of the elevator car 6 in the hoistway 4.

The propagation speed of the signal S along the rope 30 may be considered as a constant that is known to the controller 36.

The propagation speed of the signal S along the rope 30 may depend on the temperature and/or on the humidity of the air in the hoistway 4. In order to enhance the accuracy of the determined position of the elevator car 6, the controller may comprise a thermometer 52 and/or a hygrometer 54 for measuring the temperature and/or the humidity of the air in the hoistway 4. The controller 36 may adjust the propagation speed of the signal S along the rope 30 that is used for calculating the length of the section of the rope 30 between the emitter 32 and the receiver 34 based on the measured temperature and/or humidity.

It is also possible that the receiver 34 provided on top of the elevator car 6 is a first receiver 34 and that the elevator car position determining system further comprises a second receiver 48 that is provided in a known vertical distance d from the emitter 32/coil 31 at the sidewall 6c of the elevator car 6 and that is configured for detecting the signal S that has been emitted by emitter 32/coil 31 after it has traveled over the known distance d.

Such a configuration provides a propagation speed measuring device 56 that allows the controller 36 to calculate the actual the propagation speed of the signal S along the rope 30 under the current environmental conditions. This allows for determining the position of the elevator car 6 in the hoistway 4 with very high accuracy even when environmental conditions in the hoistway 4 change.

In a further embodiment, the second receiver 48 may be provided at the bottom of the elevator car 6 at a lower end 30b of the rope 30.

In such an embodiment the controller 36 is able to measure a first travel time T< of a first signal Si traveling between the emitter 32 and the first receiver 34 on top of the elevator car 6, as well as a second travel time T2 of a second signal S2 traveling between the emitter 32 and the second receiver 48 at the bottom of the elevator car 6.

If the total length of the rope 30 is known, the propagation speed of the first and second signals Si, S2 along the rope 30 as well as the position of the elevator car 6 in the hoistway 4 may be calculated from the measured first and second travel times Ti and T2.

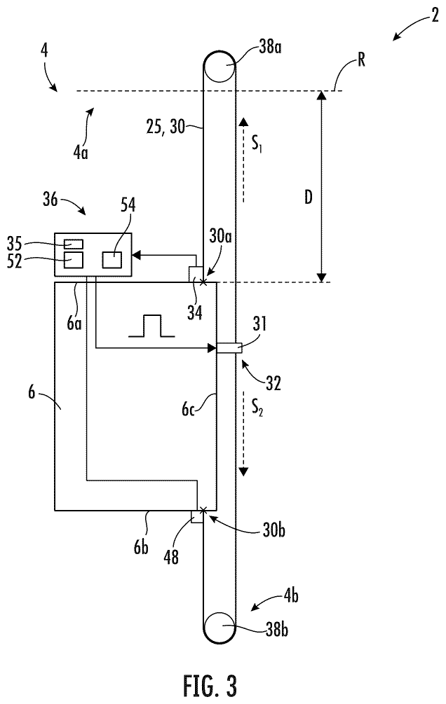

FIG. 3 depicts a schematic view of an elevator system 2 comprising an elevator car position determining system according to a further exemplary embodiment of the invention.

The embodiment depicted in FIG. 3 is similar to the embodiment depicted in FIG. 2A. The features that are identical to those of the embodiment depicted in FIG. 2A are denoted with the same reference signs and will not be discussed in detail again.

Contrary to the embodiment depicted in FIG. 2A, the elevator system 2 depicted in FIG. 3 does not comprise a propagation speed measuring device 56. Instead, the receiver 34 that is provided on top of the elevator car 6 is a first receiver 34, and a second receiver 48 is provided at the bottom of the elevator car 6 adjacent to the lower end 30b of the rope 30 mounted to the elevator car 6.

When activated, the emitter 32 emits two signals Si, S2 into the longitudinal signal transmission component 251 rope 30. The two signals Si, S2 may in particular be emitted simultaneously. The first signal Si travels from the emitter 32 to the first receiver 34 on top of the elevator car 6, as it has been described before with respect to FIG. 2A, and the controller 36 determines a first travel time T1 of said first signal Si between the emitter 32 and the first receiver 34.

The second signal S2 travels from the emitter 32 along a lower portion of the rope 30 to the second receiver 48 that is provided at the bottom of the elevator car 6. The controller 36 determines a second travel time T2 of said second signal S2 between the emitter 32 and the second receiver 48.

Since the total length of the rope 30 between its upper end 30a and its lower end 30b is constant, the total travel time Ttotai=Ti+T2, which is the sum of the first and second travel times Ti, T2, is constant as well. The total travel time Ttotai does in particular not change when the elevator car 6 moves along the hoistway 4.

The position of the elevator car 6 in the hoistway 4 may be determined from each of the ratios between one of the first and second travel times Ti, T2 and the total travel time Ttotai=Ti+T2, respectively. In other words, a first position Pi of the elevator car 6 in the hoistway 4 is a function Fi of the ratio between the first travel time Ti and the total travel time Ttotai=Ti+T2, and a second position P2 of the elevator car 6 in the hoistway 4 is a function F2 of the ratio between the second travel time T2 and the total travel time Ttotai=Ti+T2, respectively:

$$P 1 = F 1 ( T 1 / Ttotal ) ,$$

$$P 2 = F 2 ( T 2 / Ttotal ) .$$

If the elevator car position determining system operates correctly, the first and second positions Pi and P2 of the elevator car 6 are equal or, at least, differ by not more than a predefined maximum difference APmax. In case the first and second positions Pi and P2 differ by more than the predefined maximum difference APmax, a warning may be issued indicating that the elevator car position determining system might operate incorrectly.

The exemplary embodiment of an elevator car position determining system depicted in FIG. 3 allows for reliably determining the position of the elevator car 6 in the hoistway 4 without knowing or determining the propagation speed of the first and second signals Si, S2 along the rope 30.

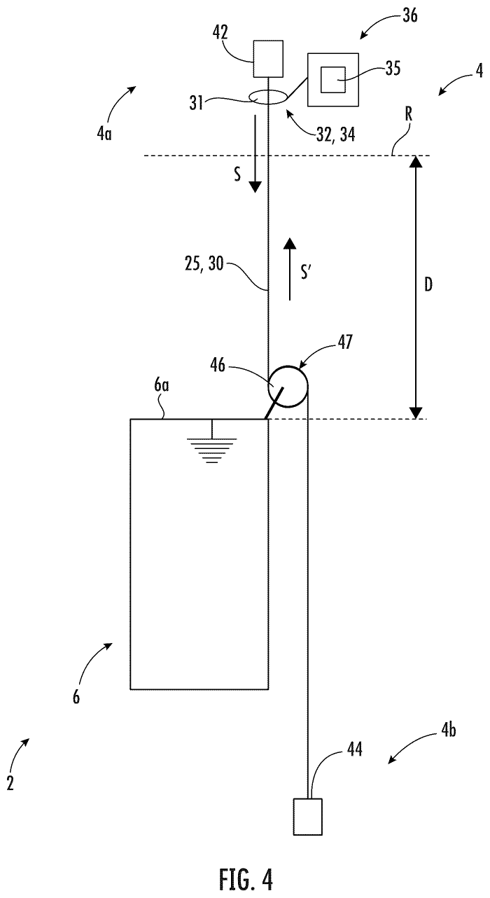

FIG. 4 depicts a schematic view of an elevator system 2 comprising an elevator car position determining system according to another exemplary embodiment of the invention.

The exemplary embodiment depicted in FIG. 4 also comprises a rope 30 extending along the longitudinal direction L of the hoistway 4.

In the embodiment depicted in FIG. 4, the rope 30 extends between an upper terminal 42 located in the vicinity of the top 4a of the hoistway 4 and a lower terminal 44 located in the vicinity of the bottom 4b of the hoistway 4.

The rope 30 extends over a car pulley 47, in particular a metallic car pulley 47, that is mounted to the roof 6a of the elevator car 6.

A combined emitter/receiver 32, 34 comprising a coil 31 is provided adjacent to the upper terminal 42 in the vicinity of the top 4a of the hoistway 4.

The emitter 32 of the combined emitter/receiver 32, 34 is configured for emitting a signal S, in particular an electromagnetic signal S, into the rope 30 so that the signal S travels along the rope 30 towards the elevator car 6.

The car pulley 47 and the elevator car 6 are electrically grounded to earth potential.

When the signal S reaches the car pulley 47 mounted to the elevator car 6, the signal S is reflected by the electrically grounded car pulley 47 that acts as a reflector 46, and the reflected signal S′ travels back to the emitter I receiver 32, 34, where it is received by the receiver 34 of the combined emitter/receiver 32, 34.

A controller 36 of the elevator car position determining system that is coupled to the combined emitter/receiver 32, 34 is capable to determine the length of the rope 30 between the combined emitter/receiver 32, 34 and the reflector 46/car pulley 47 from the measured travel time of the signals S, S′, i.e. from the time between emitting the signal S and receiving the reflected signal S′, and a known propagation speed of the signals S, S′ along the rope 30.

This allows the controller 36 to determine the distance D between the elevator car 6 and a virtual reference line R defined in the vicinity of the top 4a of the hoistway 4.

The controller 36 may comprise a Time-To-Digital-Converter (TDC) 35 for measuring the travel time of the signal S between the emitter 32 and the receiver 34.

The propagation speed of the signals S, S′ along the rope 30 may be considered as constant. Alternatively, it may be determined and/or corrected for changing environmental influences as it has been described before with respect to the embodiment depicted in FIG. 2A.

In another embodiment that is not explicitly depicted in the figures, the combined emitter/receiver 32, 34 may be arranged in the vicinity of the bottom 4b of the hoistway 4 for determining a distance D′ of the elevator car 6 from a virtual reference line (not shown) that is defined in the vicinity of the bottom 4b of the hoistway 4.

In yet another embodiment, a first combined emitter/receiver 32, 34 may be arranged in the vicinity of the top 4a of the hoistway 4 and a second combined emitter I receiver 32, 34 may be arranged in the vicinity of the bottom 4b of the hoistway 4 in order to allow the controller 36 to determine the propagation speed of the signals S, S′ along the rope 30 as well as the vertical position of the elevator car 6 in the hoistway 4 from a measured first travel time of first signals S, S′ measured by the first emitter/receiver 32, 34 that is arranged in the vicinity of the top 4a of the hoistway 4 and a measured second travel time of second signals S, S′ measured by the second emitter I receiver 32, 34 that is arranged in the vicinity of the bottom 4b of the hoistway 4.

Such a configuration may allow for determining the vertical position of the elevator car 6 in the hoistway 4 with very high accuracy.

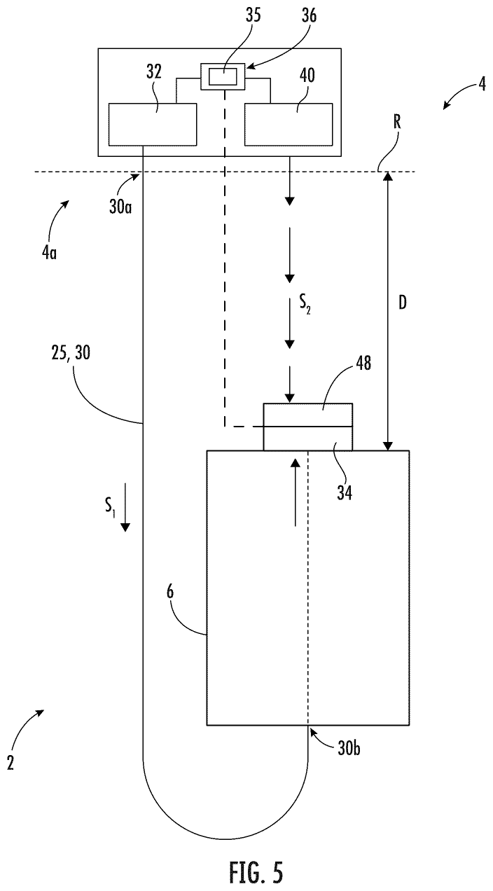

FIG. 5 depicts a schematic view of an elevator system 2 comprising an elevator car position determining system according to yet another exemplary embodiment of the invention.

The elevator system 2 according to the exemplary embodiment depicted in FIG. 5 also comprises a rope 30 extending along the longitudinal direction L between the elevator car 6 and a position in the vicinity of the top 4a of the hoistway 4.

A first emitter 32 is provided at an upper end 30a of the rope 30 at the top 4a of the hoistway 4, and a first receiver 34 is provided at a lower end 30b of the rope 30 at the elevator car 6.

The elevator system 2 depicted in FIG. 5 further comprises a second emitter 40 that is located adjacent to the first emitter 32 in the vicinity of the top 4a of the hoistway 4 and a second receiver 48 that is located next to the first receiver 34 at the elevator car 6.

In the embodiment depicted in FIG. 5, the first and second receivers 34, 48 are arranged on top of the elevator car 6. In further embodiments that are not explicitly depicted in the figures, the first and second receivers 34, 48 may also be arranged at the bottom or at a side of the elevator car 6.

The first emitter 32 is configured for emitting a first signal Si that travels through the rope 30 to the first receiver 34 provided at the elevator car 6.

The second emitter 40 is configured for emitting a second signal S2 that travels through the air in the hoistway 4 to the second receiver 48 provided at the elevator car 6.

The controller 36 is configured for measuring a first travel time T1 of the first signal Si between the first emitter 32 and the first receiver 34, and for measuring a second travel time T2 of the second signal S2 between the second emitter 40 and the second receiver 48, respectively.

The controller 36 may comprise at least one Time-To-Digital-Converter (TDC) 35 for measuring a first travel time Ti of the first signal Si between the first emitter 32 and the first receiver 34, and for measuring a second travel time T2 of the second signal S2 between the second emitter 40 and the second receiver 48, respectively.

Since the length of the rope 30 between the first emitter 32 and the first receiver 34 is constant and does not change when the elevator car 6 moves in the hoistway 4, the controller 36 may determine the propagation speed of the first signal Si between the first emitter 32 and the first receiver 34 from the measured first travel time T1.

The distance between the second emitter 40 and the second receiver 48 changes when the elevator car 6 moves in the hoistway 4. In consequence, the second travel time T2 of the second signal S2 between the second emitter 40 and the second receiver 48 changes in accordance with the position of the elevator car 6 in the hoistway 4.

In consequence, comparing the measured first travel time Ti with the measured second travel time T2 allows the controller 36 to determine the position of the elevator car 6 in the hoistway 4. It allows the controller 36 in particular to determine the distance D between the elevator car 6 and a virtual reference line R that is defined in the vicinity of the top 4a of the hoistway 4.

The use of two different channels, namely the rope 30 as a first channel and the air between the second emitter 40 and the second receiver 48 for transmitting the signals Si, S2 allows to prevent the need of reflecting the signal at the elevator car 6. This prevents occurrence of any problems related to reflecting the signal, such as misalignment of the reflector, potentially due to vibrations; damping of the signals by dust that settles on the reflector, etc.

As a result, employing two signals for determining the position of the elevator car 6 in the hoistway 4, including a first signal Si that travels over a constant distance and a second signal S2 that travels over a distance that changes in concurrence with the position of the elevator car 6, allows for enhancing the robustness of the operation of the elevator car position determining system and for a more reliable operation of the elevator system 2.

In the embodiment depicted in FIG. 5, the first and second emitters 32, 40 are stationarily arranged in the hoistway 4, in particular in the vicinity of the top 4a of the hoistway 4, and the first and second receivers 34, 48 are located at the elevator car 6.

Alternatively, the first and second emitters 32, 40 may be arranged in the vicinity of the bottom 4b of the hoistway 4.

In a further embodiment that is not explicitly depicted in the figures, the first and second emitters 32, 40 are mounted to the elevator car 6 and the first and second receivers 34, 48 are stationarily arranged in the hoistway 4, in particular in the vicinity of the top 4a of the hoistway 4.

In another embodiment, the first and second emitters 32, 40 as well as the first and second receivers 34, 48 may be arranged stationarily in the hoistway 4, and the elevator car 6 may be provided with reflectors (not shown) that are configured for reflecting the first and second signals Si, S2 back towards the first and second receivers 34, 48, respectively, similar to the embodiment depicted in FIG. 4.

Correspondingly, the first and second emitters 32, 40 as well as the first and second receivers 34, 48 may be provided at the elevator car 6, and corresponding reflectors (not shown) may be arranged stationarily in the hoistway 4 for reflecting the first and second signals Si, S2 emitted by the first and second emitters 32, 40 back towards the first and second receivers 34, 48.

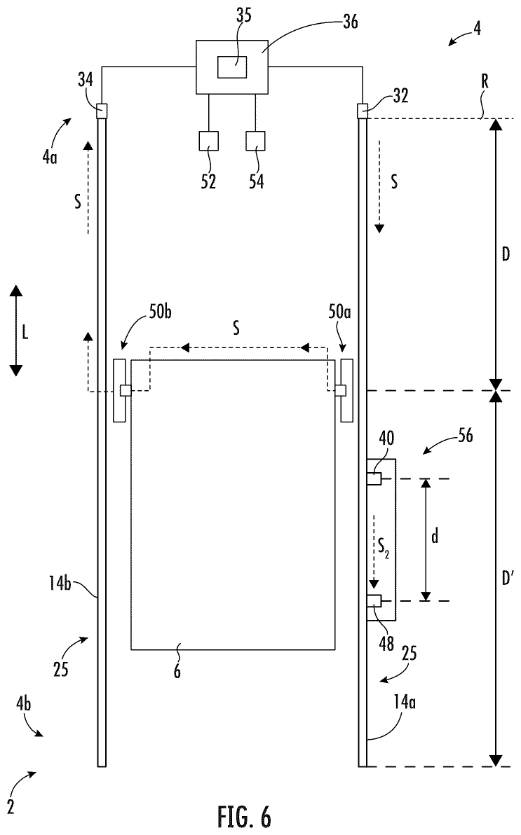

FIG. 6 depicts a schematic view of an elevator system 2 comprising an elevator car position determining system according to a further exemplary embodiment of the invention.

The elevator car 6 of the elevator system 2 depicted in FIG. 6 is configured for moving along two elevator car guide members 14a, 14b that extend parallel to each other along the longitudinal direction L in the hoistway 4.

In the embodiment depicted in FIG. 6, the elevator system 2 comprises an elevator car position determining system including an emitter 32 that is arranged at a first guide member 14a of the two guide members 14a, 14b and that is configured for emitting a signal S, in particular an electromagnetic signal S or an ultrasound signal S, into the first guide member 14a.

The elevator car position determining system further includes a receiver 34 that is arranged at a second guide member 14b of the two guide members 14a, 14b and that is configured for receiving a signal S, in particular an electromagnetic signal S or an ultrasound signal S, that is traveling through the second guide member 14b.

Thus, each guide member 14a, 14b acts as a longitudinal signal transmission component 25 transmitting the signal S.

The elevator car 6 is equipped with two couplers 50a, 50b that are configured for coupling the elevator car 6 with the first and second guide members 14a, 14b, respectively, in order to allow transferring signals S between the guide members 14a, 14b and the elevator car 6. The couplers 50a, 50b may in particular be configured for inductively or capacitively coupling the elevator car 6 with the first and second guide members 14a, 14b.

For determining the position of the elevator car 6 in the hoistway 4, the emitter 32 emits a signal S into the first guide member 14a.

The signal S emitted by the emitter 32 into the first guide member 14a travels along the first guide member 14a. When the signal S reaches the first coupler 50a provided at the elevator car 6, at least a portion of the signal is transferred via the first coupler 50a to the elevator car 6 and through the elevator car 6 to the second coupler 50b that is arranged at an opposite side of the elevator car 6 adjacent to the second guide member 14b.

The second coupler 50b transfers the signal S into the second guide member 14b. The signal S then travels along the second guide member 14b and is received by the receiver 34 provided at the top of the second guide member 14b.

A controller 36 of the elevator car position determining system is coupled to the emitter 32 and to the receiver 34. The controller 36 is configured for measuring the travel time that passes between emitting the signal S into the first guide member 14a and receiving the signal S from the second guide member 14b.

The controller 36 may comprise a Time-To-Digital-Converter (TDC) 35 for measuring the travel time of the signal S between the emitter 32 and the receiver 34.

When the propagation speed of the signal S along the guide members 14a, 14b and the time it takes the signal S to travel through the elevator car 6 is known, the controller 36 is able to calculate the distance D between the elevator 6 and a virtual reference line R that is defined in the hoistway 4 adjacent to the emitter 32 and the receiver 34.

The circuit comprising the controller 36, the emitter 32 and the receiver 34 may be galvanically isolated from the environment in order to ensure that the electromagnetic signal S travels only along the defined path including the first guide member 14a, the elevator car 6 and the second guide member 14b.

In an exemplary embodiment, the propagation speed of the signal S through the guide members 14a, 14b may be considered as constant.

As discussed above with respect to the rope 30, the propagation speed of the signal S through the guide members 14a, 14b may depend on the temperature and/or on the humidity of the air in the hoistway 4. In order to enhance the accuracy of the determined position of the elevator car 6, the controller 36 may be coupled to a thermometer 52 and/or to a hygrometer 54 that are configured for measuring the temperature and/or the humidity of the air in the hoistway 4, respectively, allowing the controller 36 to adjust the propagation speed of the signal S through the guide members 14a, 14b based on the results of these measurements.

It is also possible that an elevator car position determining system comprises at least one propagation speed measuring device 56 that is configured for measuring the propagation speed of the signal S traveling through at least one of the guide members 14a, 14b.

The at least one speed measuring device 56 may comprise a second emitter 40 and a second receiver 48 that are arranged in a defined distance d from each other at one of the guide members 14a, 14b.

For determining the propagation speed of the signal S traveling through said guide member 14a, 14b, the second emitter 40 emits a second signal S2 into the guide member 14a, 14b and the second receiver 48 receives said second signal S2 after it has traveled over the defined distance d along the guide member 14a, 14b.

Since the temperature and/or the humidity of the air in the hoistway 4 and in consequence the travel time of the signal S along the guide members 14a, 14b may be different in different heights of the hoistway 4, a plurality of speed measuring devices 56 may be provided along the length of the guide members 14a, 14b in order to allow for determining the propagation speed of the signal S in the guide members 14a, 14b at different heights. An elevator system 2 comprising a plurality of speed measuring devices 56 may allow for enhancing the accuracy of the results provided by the elevator car position determining system even further.

In order to reduce the costs of the at least one speed measuring device 56, the first emitter 32 may be employed as the second emitter 40 in combination with a second receiver 48 that is arranged in a defined distance d from the first emitter 32, or the first receiver 34 may be employed as the second receiver 48 that is configured for receiving second signals S2 emitted by a second emitter 40 that is arranged in a defined distance d from the first receiver 34.

In the exemplary embodiment depicted in FIG. 6, the first emitter 32 and the first receiver 34 are arranged at the upper ends of the guide members 14a, 14b in the vicinity of the top 4a of the hoistway 4.

The first emitter 32 and the first receiver 34 may also be arranged at the lower ends of the guide members 14a, 14b in the vicinity of the bottom 4b of the hoistway 4.

In a further embodiment, first and second emitters 32, 40 and first and second receivers 34, 48 may be provided at the upper and lower ends of the guide members 14a, 14b, respectively. Such a configuration allows the elevator car position determining system to determine the distance D of the elevator car 6 from the top 4a of the hoistway 4 as well as the distance D′ of the elevator car 6 from the bottom 4b of the hoistway 4.

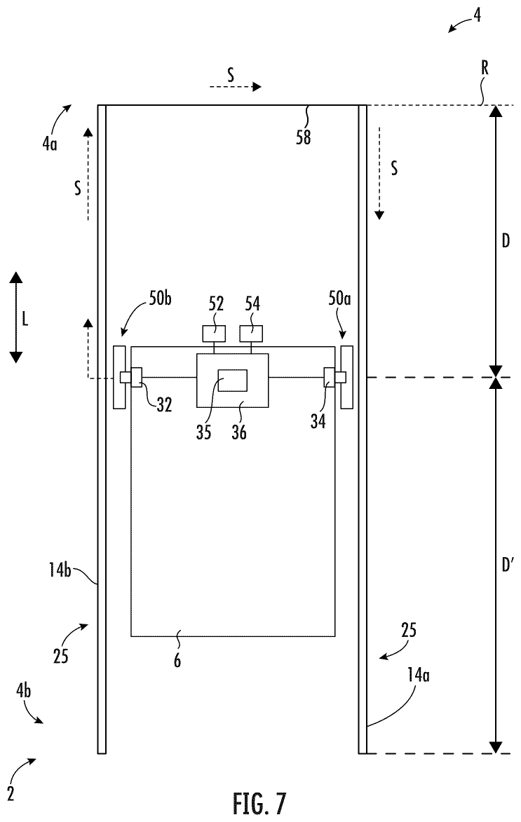

FIG. 7 depicts a schematic view of an alternative embodiment of an elevator system 2 comprising an elevator car position determining system according to an exemplary embodiment of the invention, in which the controller 36, the first emitter 32 and the first receiver 34 are arranged at the elevator car 6 and the two guide members 14a, 14b are coupled with each other by a coupling 58. This allows signals S emitted by the first emitter 32 via the first coupler 50a into the first guide member 14a to transfer into the second guide member 14b, in order to be received via the second coupler 50b by the first receiver 34 provided at the elevator car 6.

A configuration as it is depicted in FIG. 7 allows the controller 36 to determine the position of the elevator car 6 in the hoistway 4 from the travel time that passes between emitting the signal S by the first emitter 32 and receiving the signal S with the first receiver 34.

In the exemplary embodiment depicted in FIG. 7, the coupling 58 is provided at the upper ends of the two guide members 14a, 14b in the vicinity of the top 4a of the hoistway 4. In an alternative embodiment that is not explicitly depicted in the figures, the coupling 58 may be provided at the lower ends of the guide members 14a, 14b in the vicinity of the bottom 4b of the hoistway 4.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling in the scope of the dependent claims.

What is claimed is:

1. An elevator system (2) comprising:
an elevator car (6) that is configured for traveling in a hoistway (4) along a longitudinal direction (L) between a plurality of landings (8);
at least one longitudinal signal transmission component (25) made of a solid or flexible material and extending along the longitudinal direction (L) between the elevator car (6) and a defined position in the hoistway (4); and
an elevator car position determining system that is configured for transmitting a signal (S) through the at least one longitudinal signal transmission component (25);
measuring a travel time of the signal (S) that is transmitted through the at least one longitudinal signal transmission component (25); and
using the measured travel time for determining the current position of the elevator car (6) in the hoistway (4).

2. The elevator system (2) according to claim 1, wherein the signal (S) is an ultrasound signal (S) and/or an electromagnetic signal (S), in particular at least one of an inductively coupled electromagnetic signal (S), a capacitively coupled electromagnetic signal (S), and an optical signal (S).

3. The elevator system (2) according to claim 1,
further comprising at least one propagation speed measuring device (56) that is configured for measuring a propagation speed of a signal (S) traveling through the at least one longitudinal signal transmission component (25);
wherein the at least one propagation speed measuring device (56) is in particular configured for measuring the travel time of a signal (S) traveling over a predefined length through the at least one longitudinal signal transmission component (25).

4. The elevator system (2) according to claim 1, wherein the at least one longitudinal signal transmission component (25) includes at least one rigid longitudinal signal transmission component (25), in particular a guide member (14, 14a, 14b; 24), such as a guide rail, that is configured for guiding the elevator car (6) or a counterweight (16) along the hoistway (4).

5. The elevator system (2) according to claim 1, wherein the elevator car position determining system comprises
an emitter (32) that is located at a defined position in the hoistway (4), in particular at a defined position in the vicinity of a top (4a) or in the vicinity of a bottom (4b) of the hoistway (4), or at any of the elevator car (6) and a counterweight (16), wherein the emitter (32) is configured for emitting and transmitting the signal (S) into a first longitudinal signal transmission component (14a); and
a receiver (34) that is located at a defined position in the hoistway (4), in particular at a defined position in the vicinity of the top (4a) or in the vicinity of the bottom (4b) of the hoistway (4), or at any of the elevator car (6) and the counterweight (16), wherein the receiver (34) is configured for receiving the signal (S) traveling through a second longitudinal signal transmission component (14b); and wherein the elevator car (6) or the counterweight (16) is configured for transferring the signal (S) emitted by the emitter (32) from the first longitudinal signal transmission component (14a) into the second longitudinal signal transmission component (14b); or
wherein any of the elevator car (6) and the counterweight (16) is configured for transferring the signal (S) emitted by the emitter (32) at the elevator car (6) or at the counterweight (16) from the elevator car (6) or from the counterweight (16) to the first longitudinal signal transmission component (14a) and from the second longitudinal signal transmission component (14b) to the elevator car (6) or to the counterweight (16), respectively.

6. The elevator system (2) according to claim 5, wherein the elevator car (6) or the counterweight (16) is capacitively or inductively coupled to the first and second longitudinal signal transmission components (14a, 14b) for transferring the signal (S) from the first longitudinal signal transmission component (14a) to the second longitudinal signal transmission component (14b) via the elevator car (6) or via the counterweight (16), respectively, or for transferring the signal (S) from the elevator car (6) or from the counterweight (16) to the first longitudinal signal transmission component (14a) and from the second longitudinal signal transmission component (14b) to the elevator car (6) or to the counterweight (16), respectively.

7. The elevator system (2) according to claim 1, wherein the at least one longitudinal signal transmission component (25) includes a flexible longitudinal signal transmission component (25), such as a rope (30); wherein the rope (30) is in particular a hoisting rope, a governor rope, or a separate dedicated rope (30) that is provided exclusively for determining the position of the elevator car (6) in the hoistway (4).

8. The elevator system (2) according to claim 7,
wherein the elevator system (2) comprises an emitter (32) and a receiver (34) that are located at defined positions in the vicinity of a top (4a) or in the vicinity of a bottom (4b) of the hoistway (4);
wherein the elevator system (2) comprises in particular a reflector (46) that is provided at the elevator car (6) and that is configured for reflecting the signal (S) emitted by the emitter (32) towards the receiver (34); wherein the reflector (46) is in particular a car pulley (47) that is configured for deflecting the rope (30) or a terminal (42, 44) that is configured for terminating the rope (30); or
wherein the elevator system (2) comprises an emitter (32) and a receiver (34) that are located at the elevator car (6); and wherein the elevator system (2) in particular comprises a reflector (46) that is provided at a defined position in the vicinity of the top (4a) and/or in the vicinity of the bottom (4b) of the hoistway (4) and configured for reflecting the signal (S) emitted by the emitter (32) towards the receiver (34); wherein the reflector (46) is in particular a pulley that is configured for deflecting the rope (30) or a terminal (42, 44) that is configured for terminating the rope (30).

9. The elevator system (2) according to claim 1,
wherein the travel time of the signal (S) transmitted through the at least one longitudinal signal transmission component (25) is a first travel time that is independent of the position of the elevator car (6) in the hoistway (4);
wherein the elevator system (2) further comprises a second emitter (40) and a second receiver (48); wherein the second emitter (40) is configured for emitting a second signal (S2) for being transmitted to the second receiver (48) along a path having a variable length so that a second travel time of the second signal (S2) between the second emitter (40) and the second receiver (48) varies in accordance with the position of the elevator car (6) in the hoistway (4); and wherein the elevator car position determining system is further configured for
determining the second travel time and a difference between the first and second travel times; and
determining the current position of the elevator car (6) in the hoistway (4) from the difference between the first and second travel times.

10. The elevator system (2) according to claim 9,
wherein the second emitter (40) is an airborne signal emitter (40) that is configured for emitting an airborne signal (S) that is transmitted via the air or space in the hoistway (4) above and/or below the elevator car (6);
wherein the second receiver (48) is an airborne signal receiver (48) that is configured for receiving the airborne signal (S) emitted by the airborne signal emitter (40).

11. The elevator system (2) according to claim 9,
wherein the second emitter (40) is configured for emitting the second signal (S2) into a guide member (14, 14a, 14b; 24), such as a guide rail, that is configured for guiding the elevator car (6) or a counterweight (16) along the hoistway (4); and wherein the second receiver (48) is configured for receiving (34) the second signal (S2) from the or another guide member (14, 14a, 14b; 24), such as a guide rail, that is configured for guiding the elevator car (6) or a counterweight along the hoistway (4); or
wherein the second emitter (40) is configured for emitting the second signal (S2) into a rope (30), such as a hoisting rope or governor rope, that is coupled to the elevator car (6) or counterweight (16); and wherein the second receiver (48) is configured for receiving the second signal (S2) from the rope (30) that is coupled to the elevator car (6) or counterweight (16).

12. The elevator system (2) according to claim 1,
wherein the elevator car position determining system is configured for determining a distance (D) between the elevator car (6) and the top (4a) of the hoistway (4); and/or
wherein the elevator car position determining system is configured for determining a distance (D′) between the elevator car (6) and the bottom (4b) of the hoistway (4).

13. A method of determining a position of an elevator car (6) in a hoistway (4) of an elevator system (2), wherein the method comprises:
transmitting a signal (S) through at least one longitudinal signal transmission component (25) that is made of a solid or flexible material and that extends between the elevator car (6) and a defined position in the hoistway (4), in particular a defined position in the vicinity of the top (4a) or in the vicinity of the bottom (4b) of the hoistway (4);
measuring the travel time of the signal (S) that is transmitted through the at least one longitudinal signal transmission component (25); and
using the measured travel time for determining the current position of the elevator car (6) in the hoistway (4).

14. The method according to claim 13,
wherein the method includes reflecting the signal (S) with a reflector (46) that is located at the elevator car (6) or at a defined position in the hoistway (4);
wherein the reflector (46) is in particular located at a defined position in the vicinity of the top (4a) of the hoistway (4) or at a defined position in the vicinity of the bottom (4b) of the hoistway (4).

15. The method according to claim 13,
wherein the travel time of the signal (S) transmitted through the at least one longitudinal signal transmission component (25) is a first travel time that is independent of the position of the elevator car (6) in the hoistway (4);
wherein the method further includes transmitting a second signal (S2) between a second emitter (40) and second receiver (48) so that a second travel time of the second signal (S2) between the second emitter (40) and second receiver (48) varies with a variation of the position of the elevator car (6) in the hoistway (4);
determining the second travel time and a difference between the first and second travel times; and
determining the current position of the elevator car (6) in the hoistway (4) from the difference between the first and second travel times;
wherein the method in particular includes transmitting the second signal (S2) through at least one guide member (14, 14a, 14b; 24) or through air in the hoistway (4).
